(19) United States
(12) Patent Application Publication
(10) Pub. No.: US 2012/0223957 A1
(43) Pub. Date: Sep. 6, 2012

(54) IMAGE PROCESSING DEVICE, IMAGE PROCESSING METHOD AND STORAGE MEDIUM

(75) Inventor: Hirotaka YUNO, Tokyo (JP)

(73) Assignee: CASIO COMPUTER CO., LTD., Tokyo (JP)

(21) Appl. No.: 13/409,721

(22) Filed: Mar. 1, 2012

(30) Foreign Application Priority Data
Mar. 2, 2011 (JP) 2011-045039

(51) Int. Cl. G09G 5/10; G06T 11/20

(52) U.S. Cl. 345/589; 345/442

(57) ABSTRACT

An image processing device includes a first judging section, a second judging section, a halo adding section, and a painting converting section. The first judging section judges whether or not an area whose brightness is equal to or higher than a first threshold value is included in an inputted image. When the first judging section judges that an area whose brightness is equal to or higher the first threshold value is included, the second judging section judges whether or not the area has a size equal to or larger than a second threshold value. When the second judging section judges that the area has a size equal to or larger than the second threshold value, the halo adding section performs emphasis processing on the area. The painting converting section processes the image including the area on which the emphasis processing has been performed by the halo adding section.

### CROSS-REFERENCE TO RELATED APPLICATION

This application is based upon and claims the benefit of priority from the prior Japanese Patent Application No. 2011-045039, filed Mar. 2, 2011, the entire contents of which is incorporated herein by reference.

### BACKGROUND OF THE INVENTION

1. Field of the Invention

The present invention relates to an image processing device, an image processing method and a storage medium.

2. Description of the Related Art

Japanese Patent Application Laid-Open (Kokai) Publication No. 2006-031688 discloses a technology (hereinafter referred to as “conventional technology”) for processing a photorealistic image captured by an imaging device such as a digital camera into a painting-style non-photorealistic image such as an oil painting, a watercolor painting, or a pencil sketch, by which anyone can easily create a piece of art, such as an oil painting.

For example, “Café Terrace at Night” by Vincent Van Gogh (September 1888, Yale University Art Gallery) expresses human pathos by the colors of the light of an old-fashioned lamp. In this piece, Van Gogh accentuates the impression of the lamplight by drawing numerous rings of light (hereinafter referred to as halos) around the lamplight.

With this technique, more impressive paintings can be created.

### SUMMARY OF THE INVENTION

An object of the present invention is to enable the generation of a more impressive image by performing emphasis processing on an area in an image to be processed and then processing the image.

In order to achieve the above-described object, in accordance with one aspect of the present invention, there is provided an image processing device comprising: a first judging section which judges whether or not an area having brightness equal to or higher than a first threshold value is included in an inputted image; a second judging section which, when the first judging section judges that an area having brightness equal to or higher than the first threshold value is included, judges whether or not the area has a size equal to or larger than a second threshold value; an emphasis processing section which performs emphasis processing on the area, when the second judging section judges that the area has a size equal to or larger than the second threshold value; an image processing section which processes the image including the area on which the emphasis processing has been performed by the emphasis processing section.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram of an image processing device according to an embodiment;

FIG. 2 is a flowchart of operations performed by an image processing section 10;

FIG. 3A and FIG. 3B are diagrams showing an image to be processed;

FIG. 4 is a diagram showing an example of image processing when halos are not added;

FIG. 5 is a conceptual diagram showing the extraction of areas of light;

FIG. 6 is a conceptual diagram showing the determination of the sizes of the areas of light;

FIG. 7 is a conceptual diagram of light emphasis processing;

FIG. 8 is a diagram showing an example of image processing when halos are added;

FIG. 9 is a diagram showing an example in which parameters for painting conversion can be manually set; and

FIG. 10 is a configuration diagram of a backlight 9.

### DETAILED DESCRIPTION OF THE PREFERRED EMBODIMENT

An embodiment of the present invention will hereinafter be described with reference to the drawings.

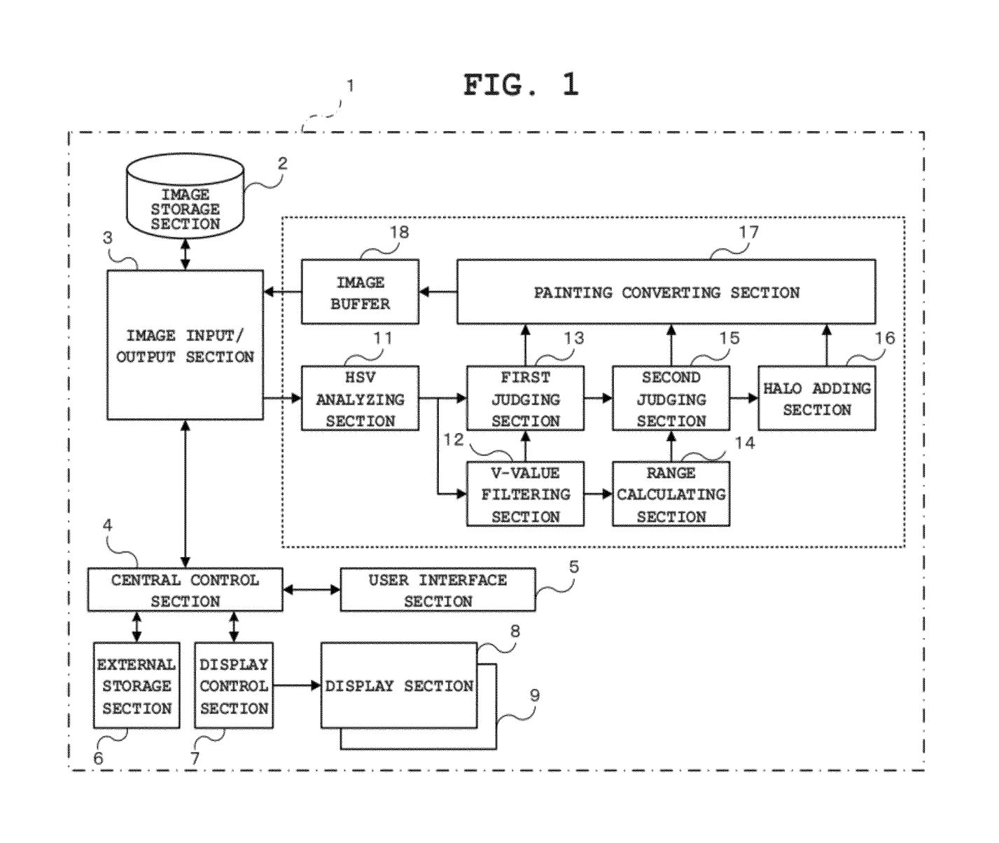

FIG. 1 is a block diagram of an image processing device according to the embodiment. In FIG. 1, the image processing device 1 is an image display system, such as a personal computer, a digital photo frame, or a digital camera, and includes an image storage section 2, an image input/output section 3, a central control section 4, a user interface section 5, an external storage section 6, a display control section 7, a display section 8, a backlight 9, and an image processing section 10 as its main components.

The image storage section 2 is a large-capacity, nonvolatile, rewritable storage device, such as a hard disk, a silicon disk, or a flash memory. This image storage section 2 stores original images (photorealistic images), painting-style images (non-photorealistic images) created by required image processing performed by the image processing section 10, etc. Note that, although this storage section is referred to as the “image” storage section 2, it may store data other than image data.

The external storage section 6 is a detachable general-purpose memory device, such as a secure digital (SD) card-type memory device that is a common storage device for digital cameras.

The image input/output section 3 reads out an image stored in the image storage section 2, and outputs it to the image processing section 10, or to the display section 8 via the display control section 7, under the control of the central control section 4. Also, the image input/output section 3 loads an image from the external storage section 6, and stores it in the image storage section 2. In addition, the image input/output section 3 loads an image from an external device such as a personal computer via an external interface (not shown), and stores it in the image storage section 2. Moreover, the image input/output section 3 outputs an image stored in the image storage section 2 to the external device.

The user interface section 5 includes operation means (such as a key device or a touch device) required for the operation of the image processing device 1. If necessary, the user interface section 5 may include a receiving section that optically or wirelessly receives operation signals from a remote controller having a function equivalent to the operation means. This user interface section 5 generates a signal corresponding to a user operation performed arbitrarily on the operation means or the remote controller, and outputs it to the central control section 4.

The display control section 7 converts display information outputted accordingly from the central control section 4 into a display signal, and outputs it to the display section 8. The display section 8 is, for example, a high-definition, two-dimensional display device, such as a liquid crystal display panel. The backlight 9 is a surface light source provided on the back surface of the display section 8.

The central control section 4 is a program-controlled control element including a storage element such as a flash memory (not shown), and a computer that executes a control program stored in advance in the storage element. Accordingly, the central control section 4 actualizes various functions required by the image processing device 1.

One is a slideshow function. The central control section 4 reads out an image stored in the external storage section 6, outputs it to the display section 8 via the display control section 7, and displays the data thereof on the display section 8. At this stage, if a plurality of images has been stored in the memory device, the central control section 4 performs a slideshow operation. In the slideshow operation, the central control section 4 reads out a single image and displays it on the display section 8. Then, after a predetermined amount of time, the central control section 4 reads out the next image and displays it on the display section 8. The central control section 4 performs this slideshow operation repeatedly. Note that the slideshow may be automatically performed when an SD card is attached to the external storage section 6, or may be arbitrarily performed in response to a user operation.

The second is an image transfer function. In this function, the central control section 4 reads out an image stored in the external storage device 6, and transfers and stores it into the image storage section 2. Image transfer from the image storage section 2 to the external storage section 6, or between the image storage section 2 and an external device such as a personal computer can also be performed. Note that the image transfer may be automatically performed when an SD card is attached to the external storage section 6, or may be arbitrarily performed in response to a user operation, as in the case of the slide show.

The third is an image processing function. In this function, the central control section 4 selects a single image from images stored in the external storage section 6 or images stored in the image storage section 2 in response to a user operation, and then performs image processing in which the selected image serving as an original image is converted to a painting-style image. Note that, although this image processing may be performed using software, it is performed using hardware in the present embodiment. That is, it is performed by the image processing section 10.

The image processing section 10 is a hardware element for image processing, and includes an HSV analyzing section 11, a V-value filtering section 12, a first judging section 13 (first judging section), a range calculating section 14, a second judging section 15 (second judging section), a halo adding section 16 (emphasis processing section), a painting converting section 17 (image processing section), and an image buffer 18.

The HSV analyzing section 11 converts the pixel values (generally RGB color model pixel values) of an image to HSV color model pixel values. The HSV color model, which expresses pixel values in hue, saturation, and value, is closer to human senses than the RGB (red, green, and blue) color model, and also referred to as the HSB color model. The converted image is hereinafter referred to as an HSV image.

The V-value filtering section 12 performs V-value filtering on an HSV image. The V-value refers to brightness (value) and indicates the brightness of a pixel. The greater the V-value is, the brighter the pixel is. The maximum V-value is white level, and the minimum V-value is black level. “V-value filtering” refers to the extraction of pixels having brightness equal to or greater than predetermined brightness (pixels whose V-value is equal to or higher than a first threshold value) from an HSV image.

The first judging section 13 judges whether or not a pixel whose V-value is equal to or higher than the first threshold value has been found in an HSV image. When judged that a pixel whose V-value is equal to or higher than the first threshold value has not been found, the first judging section 13 sends the HSV image to the painting converting section 17. Conversely, when judged that a pixel whose V-value is equal to or higher than the first threshold value has been found, the first judging section 13 sends the HSV image to the second judging section 15.

The range calculating section 14 calculates the size of an area whose V-value is equal to or higher than the first threshold value, based on a filtering result from the V-value filter section 12. This calculation is equivalent to the calculation of the size of light included in an HSV image. Note that the size herein can be rephrased as a range. When the calculated size of light is smaller than a predetermined reference value (hereinafter referred to as a second threshold value), the second judging section 15 sends the HSV image to the painting converting section 17. Conversely, when the calculated size of light is equal to or larger than the second threshold value, the second judging section 15 sends the HSV image to the halo adding section 16.

The halo adding section 16 performs a predetermined emphasis processing (processing for adding halos in this instance) on light included in an HSV image which has a size equal to or larger than the second threshold value, and sends the HSV image on which the emphasis processing has been performed to the painting converting section 17.

The painting converting section 17 performs a required image processing (for oil-painting style, watercolor painting style, pencil sketch style, or the like designated by a user operation) on an HSV image sent from the first judging section 13, an HSV image sent from the second judging section 15, or an HSV image sent from the halo adding section 16, and then outputs the processed image to the image storage section 2 via the image buffer 18, and to the display section 8 via the display control section 7.

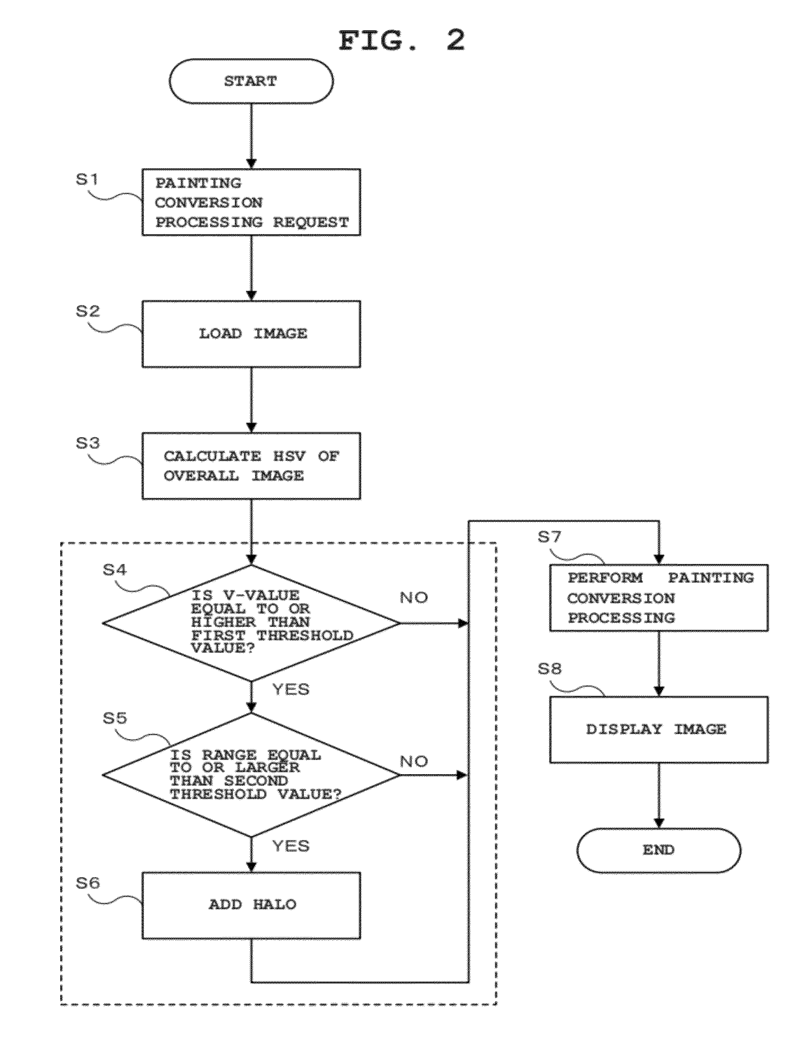

FIG. 2 is a flowchart of operations performed by the image processing section 10. Note that, in a case where software is used to perform image processing, a processing program providing functions equivalent to the operations in this flowchart is executed by the central control section 4.

In the flowchart, when a painting conversion processing request is issued by a user operation (Step S1), the image processing section 10 loads an image to be converted in response thereto (Step S2). This image to be loaded may be an image stored in the image storage section 2, or may be an image stored in the external storage section 6.

Next, the first judging section 13 calculates the pixel values in the HSV color model that is close to human senses from the pixel information of the image (Step S3), and judges whether or not a pixel whose brightness is equal to or higher than a predetermined value (a pixel whose V-value is equal to or higher than the first threshold value) is present (Step S4).

When judged that a pixel whose V-value is equal to or higher than the first threshold value is not present, the painting converting section 17 immediately performs painting conversion processing (Step S7). Conversely, when judged that a pixel whose V-value is equal to or higher than the first threshold value is present, the second judging section 15 judges whether or not the range of the pixel or pixels having a V-value equal to or higher than the first threshold value is equal to or larger than a predetermined range (the second threshold value) (Step S5). Then, when judged that the range is not equal to or larger than the second threshold value, the painting converting section 17 immediately performs painting conversion processing (Step S7). Conversely, when judged that the range is equal to or larger than the second threshold value, the painting converting section 17 performs halo adding processing to surround the light with a circle or an oval (Step S6), and then performs painting conversion processing (Step S7).

In both cases, required image processing (for oil-painting style, watercolor painting style, pencil sketch style, or the like designated by a user operation) is performed in the painting conversion processing (Step S7). Then, the painting converting section 17 outputs the processed image to the image storage section 2 via the image buffer 18 and to the display section 8 via the display control section 7 (Step S8), and completes the flow.

The above-described image processing will hereinafter be described using a specific example.

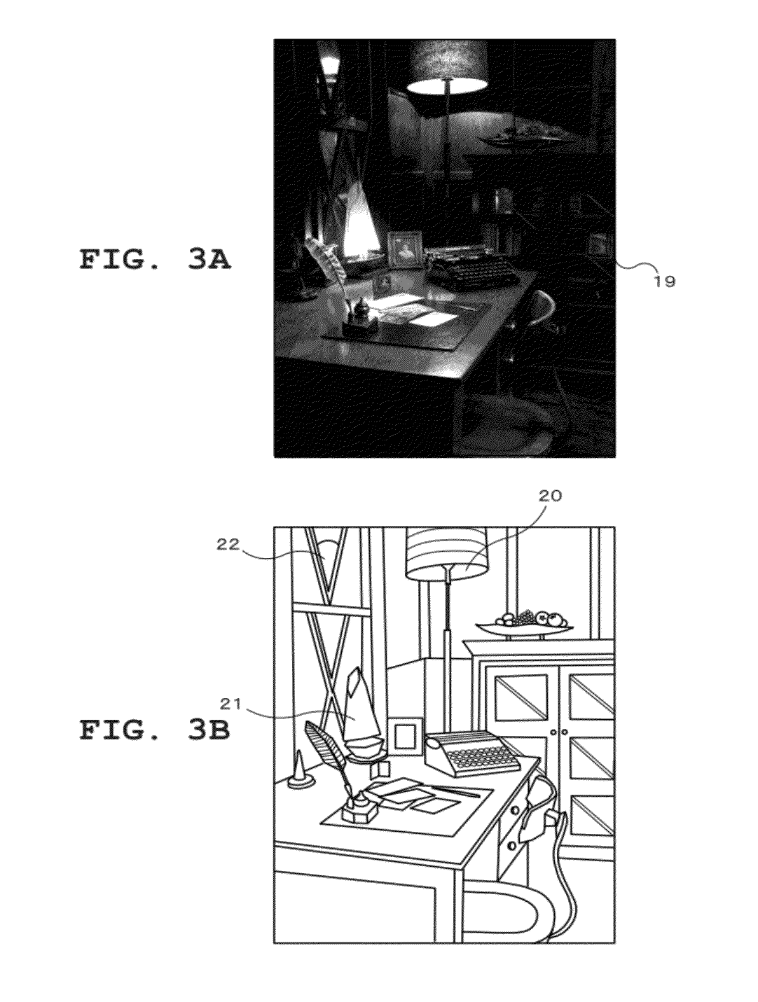

FIG. 3A and FIG. 3B are diagrams of an image to be processed, in which an image 19 showing the interior of a room is given as an example. In the image 19, several lights (a floor lamp 20, a desk lamp 21, and light 22 reflected in a mirror) have been captured. FIG. 3A is the original image of the image 19. Although this image is actually in color, it has been converted to black-and-white and dithered due to restrictions regarding patent drawings. FIG. 3B is a line drawing of the image 19 for explanation.

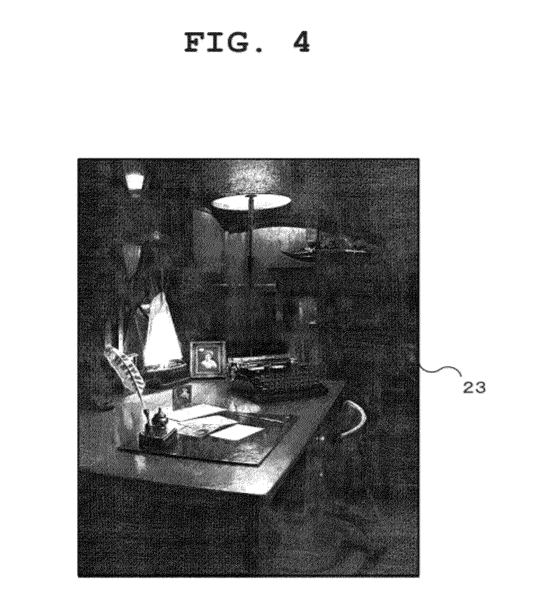

FIG. 4 is a diagram showing an example of image processing when halos are not added. In this processing example, an image 23 created by oil-painting style processing being performed on its original image (image 19) is shown, which reproduces the colors, textures, brushstrokes, etc. of oil painting. This image 23 is a painting-style non-photorealistic image and is reasonably interesting as a “piece of painting”. However, it is insufficient in terms of emphasizing the impression of light.

Accordingly, in the present embodiment, the areas of light are extracted from an original image (image 19) and, if the size of the area of light is equal to or more than a predetermined size, emphasis processing (such as adding halos) is performed on the area of the light. Then, required image processing (such as processing for oil-painting style) is performed.

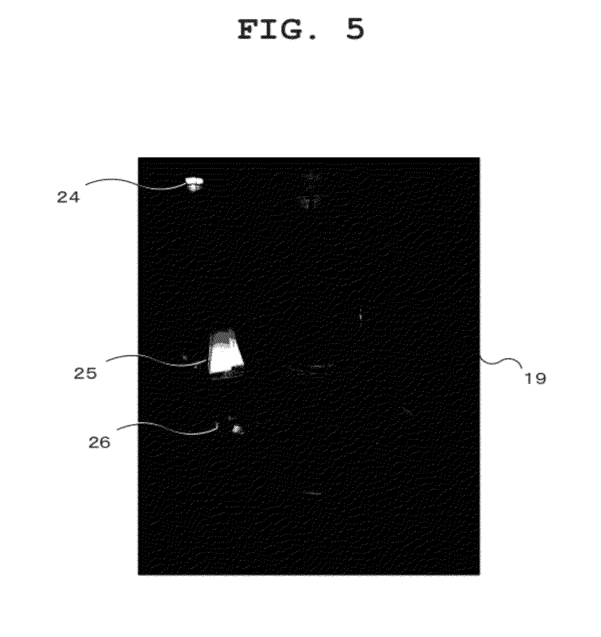

FIG. 5 is a conceptual diagram showing the extraction of the areas of light. When V-value filtering is applied to the image 19 in FIG. 5 which is an original image, areas having a V-value (brightness) equal to or higher than the first threshold value is extracted. In FIG. 5, white areas 24, 25, and 26 are the areas whose brightness are equal to or higher than the first threshold value.

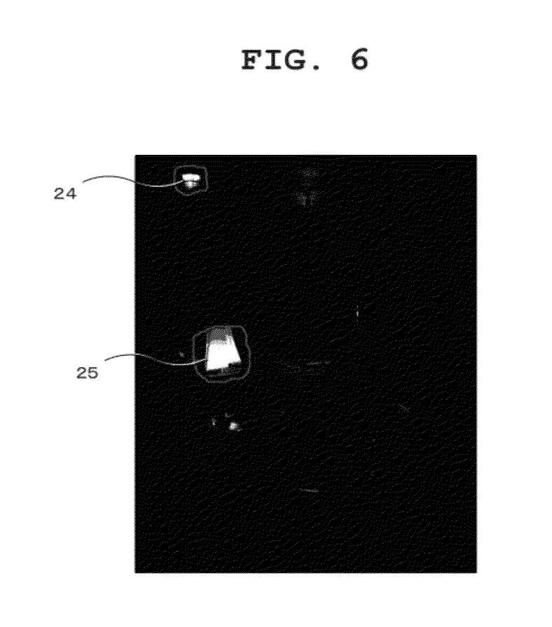

FIG. 6 is a conceptual diagram showing the judgment of the size of the area of light. In FIG. 6, a framing line has been drawn around two areas 24 and 25 among the white areas 24, 25, and 26 in FIG. 5. This indicates that the sizes of the two areas 24 and 25 are equal to or larger than the second threshold value.

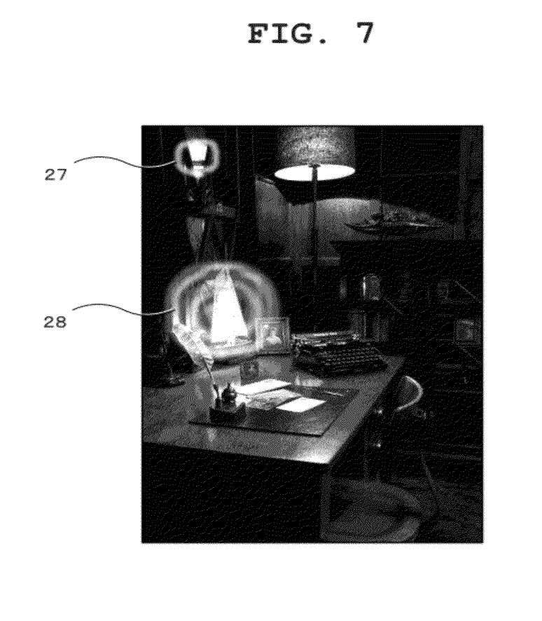

FIG. 7 is a conceptual diagram showing emphasis processing for the areas of light. In FIG. 7, emphasis processing is performed on the periphery of lights (see the white areas 24 and 25 in FIG. 6) whose sizes are equal to or larger than the second threshold value. Note that an example of the emphasis processing herein is the addition of halos 27 and 28, and the halo herein refers to a ring of light. The ring may be circular or oval-shaped, and the size thereof is preferably changed in proportion to the size of light to be processed. In addition, the number thereof is not limited to one, and a plurality of rings maybe added. In a case where a plurality of rings is added, the brightness may be reduced towards the outer side. Moreover, the color of the halo may be the same as that of the light, or may be similar color, and the halo may be made slightly transparent such that the background is visible through the halo. Furthermore, the ring may be not continuous, or in other words, may be a dotted ring. In this case, gaps between the dots may be a single gap or a plurality of gaps.

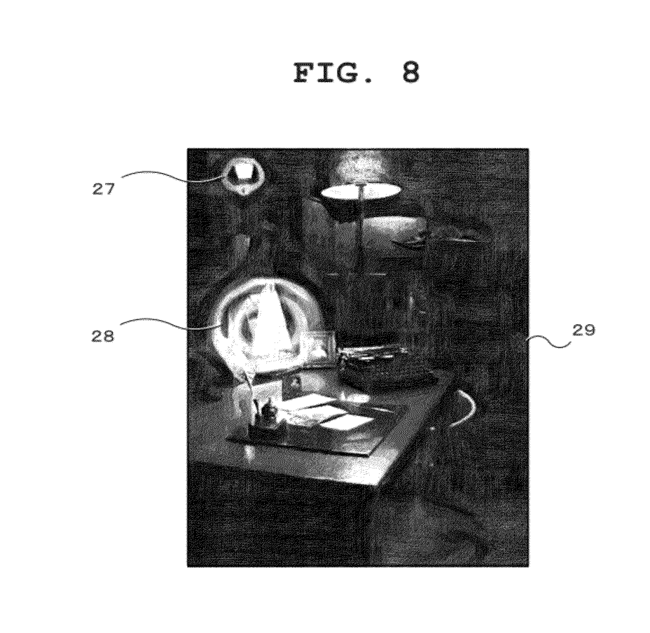

FIG. 8 is a diagram showing an example of image processing when halos are added. In this processing example as well, an image 29 on which oil-painting style processing has been performed is shown, as in the case of FIG. 4. However, unlike the case of FIG. 4, the oil-painting style processing has not been performed on the original image 19 itself. It has been performed on an image created by the halos 27 and 28 being added to the original image 19. Accordingly, in the processed image in FIG. 8, the impression of light is further emphasized by the halos 27 and 28 in addition to the colors, textures, brushstrokes, and the like of oil painting being reproduced, which makes the painting aesthetically superior.

In the present embodiment, when an area of light is present within an image, a halo is added to the area of light, and then image processing is performed, as described above. That is, emphasis processing is performed on light. Therefore, an advantage is achieved in that a more impressive painting can be created.

Note that the parameters (the first threshold value and the second threshold value) for painting conversion in the above-described embodiment maybe arbitrarily changed according to user preference.

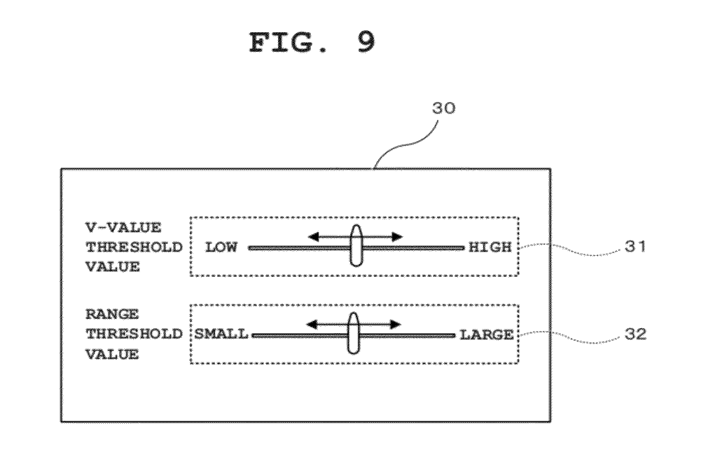

FIG. 9 is a diagram showing an example in which the parameters for painting conversion can be manually set. In FIG. 9, two slider controls 31 and 32 are provided on an interface screen 30. A first slider control 31 located in the upper portion is used to set the threshold value of the V-value which corresponds to the first threshold value, and a second slider control 32 located in the lower portion is used to set the threshold value of the range which corresponds to the second threshold value.

When the indicator of the first slider control 31 is dragged and moved to the left, the first threshold value is decreased, whereby darker lights can be extracted. Conversely, when the indicator is moved to the right, the first threshold value is increased, whereby brighter lights can be extracted.

In addition, when the indicator of the second slider control 32 is dragged and moved to the left, the range threshold value is decreased, whereby halos can be added even to small lights. When the indicator is moved to the right, the range threshold value is increased, whereby halos can be added to only larger lights.

By setting the first threshold value and the range threshold value through trial and error while checking the quality of the piece, the user can add to the piece a light-emphasis effect suited to the preference of the user.

In the above-described embodiment, lights are emphasized by image processing as described above. However, the present invention is not limited thereto. For example, the local luminance control of the backlight 9 may be used in combination. As a result of the background luminance (backlight luminance) of the area of light in an image being increased, the light emphasis processing can be performed exactly as viewed.

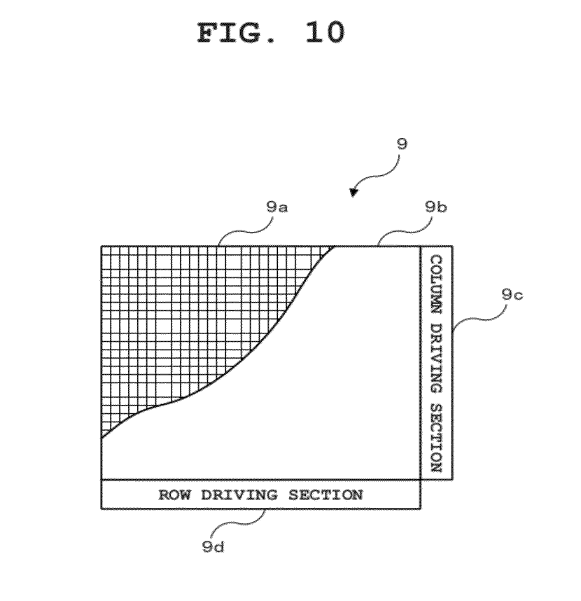

FIG. 10 is a configuration diagram showing the backlight 9 capable of performing local luminance control. In FIG. 10, the backlight 9 includes a light emitting panel 9a in which numerous point light sources (such as light emitting diodes [LEDs]) are arrayed in a matrix of rows and columns, a light diffusing plate 9b that covers the surface of the light emitting panel 9a, and a column driving section 9c and a row driving section 9d that individually control the luminance of the point light sources.

The backlight 9 configured as described above ordinarily operates as surface light source for the display section 8. However, when a non-photorealistic image, such as that in FIG. 8, is displayed on the display section 8, the backlight 9 increases the background luminance of the areas of the light (the luminance of the backlight 9) locally, and thereby performs light-emphasized display.

While the present invention has been described with reference to the preferred embodiments, it is intended that the invention be not limited by any of the details of the description therein but includes all the embodiments which fall within the scope of the appended claims.

What is claimed is:

1. An image processing device comprising:
a first judging section which judges whether or not an area having brightness equal to or higher than a first threshold value is included in an inputted image;
a second judging section which, when the first judging section judges that an area having brightness equal to or higher than the first threshold value is included, judges whether or not the area has a size equal to or larger than a second threshold value;
an emphasis processing section which performs emphasis processing on the area, when the second judging section judges that the area has a size equal to or larger than the second threshold value;
an image processing section which processes the image including the area on which the emphasis processing has been performed by the emphasis processing section.

2. The image processing device according to claim 1, wherein the emphasis processing section performs emphasized display of the area by adding a circle or an oval around the area.

3. The image processing device according to claim 2, wherein the emphasis processing section performs the emphasis processing such that the size of the circle or the oval is proportional to the size of the area which has been judged to be equal to or larger than the second threshold value by the second judging section.

4. The image processing device according to claim 2, wherein the emphasis processing section performs the emphasis processing on the area by increasing number of circles or ovals in proportion to the brightness of the area.

5. The image processing device according to claim 1, wherein the emphasis processing section performs the emphasis processing on the area by locally increasing backlight luminance of a display section which displays the image.

6. The image processing device according to claim 1, wherein the image processing section converts the image on which the emphasis processing has been performed to an image having a specific painting style.

7. An image processing method comprising:
a first judgment step of judging whether or not an area having brightness equal to or higher than a first threshold value is included in an inputted image;
a second judgment step of, when an area having brightness equal to or higher than the first threshold value is judged to be included at the first judgment step, judging whether or not the area has a size equal to or larger than a second threshold value;
an emphasis processing step of performing emphasis processing on the area, when the area is judged to have a size equal to or larger than the second threshold value at the second judgment step;
an image processing step of processing the image including the area on which the emphasis processing has been performed at the emphasis processing step.

8. A non-transitory computer-readable storage medium having stored thereon a program that is executable by a computer, the program being executable by the computer to perform functions comprising:
first judgment processing for judging whether or not an area having brightness equal to or higher than a first threshold value is included in an inputted image;
second judgment processing for, when an area having brightness equal to or higher than the first threshold value is judged to be included in the first judgment processing, judging whether or not the area has a size equal to or larger than a second threshold value;
emphasis processing for, when the area is judged to have a size equal to or larger than the second threshold value in the second judgment processing, performing emphasis processing on the area;
image processing for processing the image including the area on which the emphasis processing has been performed in the emphasis processing.
